(19) United States
(12) Patent Application Publication
(10) Pub. No.: US 2024/0276065 A1
(43) Pub. Date: Aug. 15, 2024

(54) METHOD FOR LIVING TV PROGRAM RECOMMENDATION BASED ON DIFFERENT TIME-PERIODS ON SET-TOP BOX (STB)

(71) Applicant: ARRIS Solutions LLC, Hickory, NC (US)

(72) Inventors: Lingfeng HOU, Zhengzhou (CN); Ji CHEN, Shanghai (CN); Ye-Yi CUI, Shanghai (CN); Yu-An CHEN, Shanghai (CN); Bing YAO, Shanghai (CN)

(21) Appl. No.: 18/437,765

(22) Filed: Feb. 9, 2024

(30) Foreign Application Priority Data
Feb. 10, 2023 (CN) 202310099545.1

(51) Int. Cl. H04N 21/466; H04N 21/482

(52) U.S. Cl. CPC H04N 21/4668; H04N 21/4826

(57) ABSTRACT

The present disclosure relates to an electronic device and its execution method and a computer-readable medium. An electronic device includes: a memory, in which instructions are stored; and a processor, configured to execute the instructions stored in the memory to cause the electronic device to execute the following operations: determining a plurality of different time periods; collecting information about the viewing habits for the plurality of different time periods; and generating a recommended list in real time for each of the plurality of different time periods based on the collected information; wherein the recommended list for each time period is based on the collected information about the viewing habits for that time period of that day.

### TECHNICAL FIELD

The present disclosure relates generally to the field of electronic technology, and more particularly to methods and apparatuses for generating a recommended list for live TV programs.

### BACKGROUND ART

A Set Top Box (STB) is a device that connects display devices to external sources. A STB converts compressed digital signals into TV programs and displays them on display devices such as TV sets. In prior art, the user interface of the STB is pre-customized and unified for all users. Typically, there are many live TV programs available on the STB. Users can select the programs they want to watch via the Electronic Program Guide (EPG) or TV settings menu using up/down keys, digital keys, etc. Due to the large number of program content, users may need to spend a lot of time browsing the program list to find programs of interest.

There still exists a need for users to find programs of interest conveniently.

### SUMMARY OF THE DISCLOSURE

Some aspects of the present disclosure relate to an electronic device, comprising: a memory, in which instructions are stored; and a processor, configured to execute the instructions stored in the memory to cause the electronic device to execute the following operations: determining a plurality of different time periods; collecting information about the viewing habits for the plurality of different time periods; and generating a recommended list in real time for each of the plurality of different time periods based on the collected information; wherein the recommended list for each time period is based on the collected information about the viewing habits for that time period of that day.

In some aspects, the processor is further configured to execute the instructions stored in the memory to cause the electronic device to execute the following operations: displaying the generated recommended list for the current time period when the electronic device is activated, when the user switches to the live mode, or through the user selection.

In some aspects, the processor is further configured to execute the instructions stored in the memory to cause the electronic device to execute the following operation: playing the program with the highest priority in the generated recommended list for the current time period when the electronic device is activated or when the user switches to the live mode.

In some aspects, the information about the viewing habits includes one or more of channel number, channel name, the viewing duration, the program name, the viewing time, and the program type.

In some aspects, the processor is further configured to execute the instructions stored in the memory to cause the electronic device to execute the following operations: sequencing the programs on the recommended list by the viewing duration.

In some aspects, the recommended list generated for each time period of the weekend is based on information collected about the viewing habits for that time period of the weekend.

In some aspects, the recommended list includes unviewed programs in the same type of programs in the collected information.

In some aspects, the processor is further configured to execute the instructions stored in the memory to cause the electronic device to execute the following operations: Adding or removing programs from the recommended list based on user selection or adjusting the sequence of programs in the recommended list based on user input.

Some aspects of the present disclosure relate to a method executable by an electronic device, including: determining a plurality of different time periods; collecting information about the viewing habits for the plurality of different time periods; and generating a recommended list in real time for each of the plurality of different time periods based on the collected information; wherein the recommended list for each time period is based on the collected information about the viewing habits for that time period of that day.

In some aspects, the method further comprises: displaying the generated recommended list for the current time period when the electronic device is activated, when the user switches to the live mode, or through the user selection.

In some aspects, the method further comprises: playing the program with the highest priority in the generated recommended list for the current time period when the electronic device is activated or when the user switches to the live mode.

In some aspects, the information about the viewing habits includes one or more of channel number, channel name, the viewing duration, the program name, the viewing time, and the program type.

In some aspects, the method further comprises: sequencing the programs in the recommended list by the viewing duration.

In some aspects, the recommended list generated for each time period of the weekend is based on information collected about the viewing habits for that time period of the weekend.

In some aspects, the recommended list includes unviewed programs in the same type of programs in the collected information.

In some aspects, the said method comprises: adding or removing programs from the recommended list based on user selection or adjusting the sequence of programs in the recommended list based on user input.

Some aspects of the present disclosure relate to a non-transitory computer-readable medium, in which instructions are stored, and the instructions, when executed by a processor of an electronic device, cause the electronic device to execute the following operations: determining a plurality of different time periods; collecting information about the viewing habits for the plurality of different time periods; and generating a recommended list in real time for each of the plurality of different time periods based on the collected information; wherein the recommended list for each time period is based on the collected information about the viewing habits for that time period of that day.

In some aspects, the said instructions, when executed by the processor of the electronic device, further cause the said electronic device to perform the following operations: displaying the generated recommended list for the current time period when the electronic device is activated, when the user switches to the live mode or through user selection.

In some aspects, the said instructions, when executed by the processor of the electronic device, further cause the said electronic device to perform the following operations: playing the program with the highest priority in the generated recommended list for the current time period when the electronic device is activated or when the user switches to the live mode.

In some aspects, the information about the viewing habits includes one or more of channel number, channel name, the viewing duration, the program name, the viewing time, and the program type.

In some aspects, the said instructions, when executed by the processor of the electronic device, further cause the said electronic device to perform the following operations: sequencing the programs in the recommended list by the viewing duration.

In some aspects, the recommended list generated for each time period of the weekend is based on information collected about the viewing habits for that time period of the weekend.

In some aspects, the recommended list includes unviewed programs in the same of programs in the collected information.

In some aspects, the said instructions, when executed by the processor of the electronic device, further cause the said electronic device to perform the following operations: adding or removing programs from the recommended list based on user selection or adjusting the sequence of programs in the recommended list based on user input.

Some aspects of the present disclosure relate to a computer program product, including computer instructions, which implement the method according to any one of the above when executed by a processor.

### BRIEF DESCRIPTION OF THE ATTACHED DRAWINGS

For a better understanding of the present disclosure and to show how to realize the present disclosure, examples are herein described with reference to the attached drawings, in which:

FIG. 1 is a schematic diagram of an exemplary electronic device according to an example of the present disclosure;

FIG. 2 is a schematic diagram of an exemplary network environment according to an example of the present disclosure;

FIG. 3 is an exemplary flowchart of a method for an electronic device according to an example of the present disclosure; and

FIG. 4 shows an example diagram of a recommended list generated for weekdays, consistent with examples of the present disclosure.

It should be noted that throughout the attached drawings, similar reference numerals and signs refer to corresponding parts.

### SPECIFIC EXEMPLARY EMBODIMENTS

The following detailed description is made with reference to the attached drawings, and the following detailed description is provided to facilitate comprehensive understanding of various exemplary examples of the present disclosure. The following description includes various details to facilitate understanding. However, these details are merely considered as examples, not for limiting the present disclosure. The words and phrases used in the following description are only used to enable a clear and consistent understanding of the present disclosure. In addition, for clarity and brevity, descriptions of well-known structures, functions, and configurations may be omitted. Those of ordinary skill in the art will realize that various changes and modifications can be made to the examples described in the present specification without departing from the gist and scope of the present disclosure.

As mentioned previously, the user obtains television program resources through the STB. There are often many live programs to choose from on the STB. Many of these live programs are distributed across different channels over different time periods. Users may need to spend a significant amount of time locating programs of interest. For example, users may browse the programs being played on different channels and the programs to be played in future time periods by viewing the Electronic Program Guide on the user interface of the STB. The pre-built user interface in the existing STB is uniform for all users. Due to the large number of program resources, and different viewing habits of different users, the unified program list on the user interface of the STB may not help a lot for different users to search and query personalized program.

Different users may need different program recommended lists due to different viewing habits. Also, even for the same user, there may be different viewing habits over different time periods, and the program recommended list required may be different. For example, users generally watch TV shows during the evening hours, and may watch live football games during these evening hours of a World Cup period. Therefore, a fixed program list does not make it easy for users to quickly find programs of interest. In addition, the live program is different from the on-demand program. The playing time or the content of the live program is designated by an operator (e.g., a content provider such as a multiple system operator (MSO)) and thus the content of the live program is relatively fixed for each channel in each time period. Thus, there remains a need to generate a recommended list suitable for live TV programs.

The inventor of the present disclosure has discovered that users may have different viewing preferences over different time periods. For example, users may watch a news show in the morning, a TV show in the evening, and so on. In addition, during weekends, users may watch a variety of programs different from those they watch on weekdays. During certain special times, such as the World Cup period described above, users also develop game-specific viewing habits. For example, due to jet lag, the live streaming time of the game may be a break for previous users. During this special period, users may watch TV programs during their original break in order to watch the live game when it is shown. Thus, the recommended list generated based on the viewing habits of different time periods can help users quickly find programs of interest to improve the user experience. In addition, by generating a program recommended list in real time, changes in users' viewing habits can be fully considered, so that the recommended list is more suitable for specific users, thereby helping them to better watch the program.

Those skilled in the art will understand that although the above description is set forth with the STB device as an example, the technical solution of the present disclosure is not limited to STB devices, but can be applied to various electronic devices that might be used to display an EPG to help users obtain a better viewing experience.

Next, the examples of the present disclosure will be described in detail with reference to the accompanying drawings.

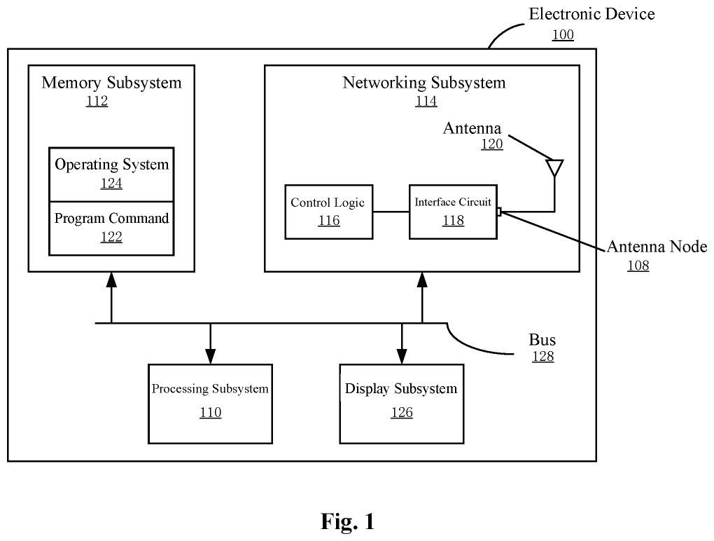

FIG. 1 presents a block diagram illustrating an exemplary electronic device 100 according to some examples.

The electronic device 100 may be used to implement various examples of the method described below according to the present disclosure. The electronic device 100 may include a processing subsystem 110, a memory subsystem 112, and a networking subsystem 114. The processing subsystem 110 includes one or a plurality of devices configured to execute computing operations. For example, the processing subsystem 110 may include one or a plurality of microprocessors, ASICs, microcontrollers, programmable logic devices, graphics processing units (GPU) and/or one or a plurality of digital signal processors (DSPs).

The memory subsystem 112 includes one or a plurality of devices for storing data and/or instructions used for the processing subsystem 110 and the networking subsystem 114. For example, the memory subsystem 112 may include a dynamic random-access memory (DRAM), static random-access memory (SRAM), and/or other types of memory (sometimes collectively or individually referred to as “computer-readable storage medium”).

In some examples, the memory subsystem 112 is coupled to one or a plurality of high-capacity mass storage devices (not shown). For example, the memory subsystem 112 may be coupled to a magnetic or an optical driver, a solid-state driver, or another type of mass storage device. In these examples, the electronic device 100 may use the memory subsystem 112 as a fast-access storage of frequently used data, while the mass storage device is used for storing infrequently used data.

The networking subsystem 114 comprises one or a plurality of devices that are configured to be coupled to and/or communicate over wired and/or wireless networks (for example, to execute network operations), comprising: control logic 116, interface circuit 118, and one or a plurality of antennas 120 (or antenna elements). (Although FIG. 1 includes one or a plurality of antennas 120, in some examples, the electronic device 100 includes one or a plurality of nodes, such as a node 108, which may be coupled to one or a plurality of antennas 120. Therefore, the electronic device 100 may or may not include one or a plurality of antennas 120.) For example, the networking subsystem 114 may include a Bluetooth networking system, a cellular networking system (for example, 3G/4G/5G networks, such as UMTS and LTE), a USB networking system, a networking system based on the standards described in IEEE 802.11 (for example, a Wi-Fi networking system), Ethernet networking system, and/or another networking system.

In the electronic device 100, a bus 128 is used to couple the processing subsystem 110, the memory subsystem 112, and the networking subsystem 114 together. The bus 128 may include electrical, optical, and/or electro-optical connections of the subsystems through which commands, data and the like may be transmitted. Although only one bus 128 is shown for clarity, different examples may include electrical, optical, and/or electro-optical connections of different numbers or configurations among the subsystems.

In some examples, the electronic device 100 includes a display subsystem 126 for showing information on a display device, which may include a display driver and a display, such as a liquid crystal display and a multi-touch screen.

Although specific components are used to describe the electronic device 100, in alternative examples, different components and/or subsystems may exist in the electronic device 100. For example, the electronic device 100 may include one or a plurality of additional processing subsystems, memory subsystems, networking subsystems, and/or display subsystems. In addition, the electronic device 100 may not have one or a plurality of the subsystems. Furthermore, in some examples, the electronic device 100 may include one or a plurality of additional subsystems not shown in FIG. 1. Also, although separate subsystems are shown in FIG. 1, in some examples, some or all of the given subsystems or components may be integrated into one or a plurality of the other subsystems or components in the electronic device 100. For example, in some examples, an operating system 124 includes program instructions 122 and/or the interface circuit 118 includes control logic 116.

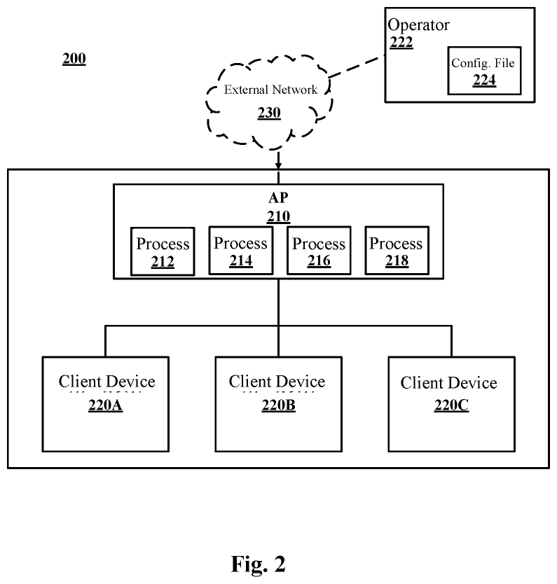

FIG. 2 is a schematic diagram showing an exemplary network environment 200 comprising the electronic device shown in FIG. 1 according to an example of the present disclosure.

The exemplary network environment 200 may include an AP 210 and one or a plurality of client devices 220A, 220B, and 220C (hereinafter, collectively referred to as client device 220 for simplicity). The electronic device 100 shown in FIG. 1 may be implemented as the access point (AP 210) or a part thereof as shown in FIG. 2, or as a client device or a part thereof.

An AP is an access point device specified according to the 802.11 protocol, for example. The AP 210 is used to provide wireless network connection for the client device 220. Specifically, the AP 210 may receive/route various types of communications from the client device 220 and/or transmit/route various types of communications to the client device 220. The AP 210 may run one or more processes 212, 214, 216, and 218 to complete the desired operations. It should be noted that the AP described herein may include routers, gateways, home controllers, set-top boxes, and other devices with AP functions.

In some examples, the client device 220 may be any electronic device having at least one network interface. For example, the client device 220 may be: a desktop computer, a laptop computer, a server, a mainframe computer, a cloud-based computer, a tablet computer, a smart phone, a smart watch, a wearable device, a consumer electronic device, a portable computing device, a radio node, a router, a switch, a repeater, an access point and/or other electronic devices. The client device 220 communicates with the AP 210 using its network interface, thereby accessing the external network 230 via the AP 210. Although three client devices are shown in FIG. 2, it should be understood that the number of client devices that the AP 210 is capable of connecting to may be fewer or more than three, depending on the network capacity supported by the AP 210.

The external network 230 may be a wide area network (WAN), such as the Internet. The AP 210 may be connected to an operator 222 of an access point device via the external network 230. The AP 210 may receive a configuration file 224 from the operator 222 over the external network. Configuration of various parameters of the access point device may be completed according to the configuration file. The operator 222 may be a multiple system operator (MSO). Those skilled in the art will understand that MSO may provide network services through a computer, a server, etc.

Those skilled in the art will understand that although the implementation of AP 210 as the STB device and the implementation of client device 220 as the display device are used as embodiments here, the technical solution of the present disclosure is not limited to this embodiment, but may be applied to various electronic devices to help users obtain a better viewing experience.

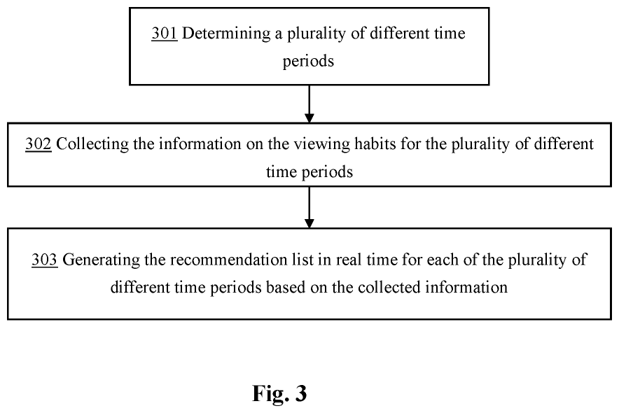

FIG. 3 is a flowchart of a method 300 for an electronic device according to an example of the present disclosure. The method 300 may be used, for example, for an electronic device 100 as shown in FIG. 1, such as a display device, or the method 300 may be used, for example, for an AP 210 as shown in FIG. 2, such as a STB device.

The technical solutions provided by the present disclosure will be described below with reference to FIG. 3.

In Step 301, a plurality of different time periods are determined. As previously described, users may have different viewing preferences over different time periods. For example, users may watch a news show in the morning, a TV show in the evening, etc. Accordingly, time-period-specific viewing preference information may be used for providing users with appropriate recommended programs. The time of the day can first be divided into several different time periods.

According to an example of the present disclosure, the time of the day may be divided into a plurality of time periods at fixed time intervals. For example, the time of the day may be divided into 24 different time periods with one hour as a fixed time interval. Those skilled in the art will understand that other fixed time intervals may also be employed.

According to another example of the present disclosure, time periods may be divided at different time intervals. For example, for daytime, the user watch time is longer and can be divided at smaller intervals, while for nighttime, the user watch time is shorter and can be divided at larger intervals. For example, the time from 7 a.m. to 21 p.m. may be divided at 30-minute intervals, while other time may be divided at 2-hour intervals. Those skilled in the art will understand that other time intervals may also be employed.

According to another example of the present disclosure, the time of the day may be divided according to the number of times the user watches TV programs. For example, for the time when TV shows are viewed more often, such as 7 a.m. to 8 a.m. and 7 p.m. to 10 p.m., a smaller time interval may be used for dividing the time, while a larger time interval may be used for other time.

According to an example of the present disclosure, the determined plurality of time periods may be adjusted according to changes in the viewing habits of the users. For example, when a user adjusts the morning viewing time to 6-7 a.m., a smaller time interval may be used to divide the time between 6 a.m. and 7 a.m.

Returning to FIG. 3, in Step 302, information about the viewing habits for a plurality of different time periods is collected.

According to an example of the present disclosure, information about viewing habits includes one or more of channel number, channel name, the viewing duration, the program name, the viewing time, and the program type. For example, the program sequence number, viewing time, viewing duration, and program type of a TV program watched by a user can be recorded. For example, the user watches a Program A for 30 minutes at 7:00 a.m. on Monday: Program A is a news program, and the program serial number may be a playback channel number, such as Channel 11. The user watches Program b for 10 minutes at 7:20 a.m. on Tuesday: Program B is a news program, and Program B is played on Channel 1. If 6-8 a.m. is the determined time period, the two pieces of viewing information described above are recorded as the information about the viewing habits for that time period.

For example, the user watches Program C at 8:00 p.m. for 50 minutes: Program C is a TV series program, and Program C is played on Channel 8; the user watched Program D at 9:00 p.m. for 50 minutes: Program D is a TV series program, and Program D is played on Channel 8. If 8-10 p.m. is the determined time period, the two pieces of viewing information described above is recorded as the information about the viewing habits for that time period.

Those skilled in the art will understand that the above only exemplarily illustrates information about viewing habits that may be collected, and may also record other information about viewing habits to make the recommendation information generated for the user more effective.

According to an example of the present disclosure, the collected viewing program information may be stored in the memory of the STB device. According to another example of the present disclosure, the collected viewing program information may be sent to the server.

Returning to FIG. 3, in Step 303, a recommended list is generated in real time for each of the plurality of different time periods based on the collected information, wherein the recommended list for each time period is based on the collected information about the viewing habits for that time period of that day. For example, by analyzing the viewing habits information collected during the time period from 6 a.m. to 8 a.m. each day, it can be determined that there are more news programs that the user is watching during the time period a, b, c, d, etc. Based on this analysis, a recommended list for news programs can be generated for that time period. Those skilled in the art will understand that the above is only an exemplary description of generating a recommended list, and that the recommended list may also be generated by other means of analysis based on the information collected.

According to an example of the present disclosure, the programs in the recommended list are sequenced according to the viewing duration. For example, if it is determined that the user has watched news programs A, B, C, D during the time period, and the cumulative viewing duration is 60 minutes for Program A, 20 minutes for Program B, 15 minutes for Program C, and 70 minutes for Program D, a list of recommendations in the sequence D, A, B, and C may be generated for the time period. Those skilled in the art will understand that the above is only an exemplary description of the sequencing of programs in the recommended list, and the programs in the recommended list may also be sequenced in other ways according to the viewing duration. For example, the program with the shortest viewing duration can also be placed on the first line and the program with the longest viewing duration on the second line, making it easier for the users to find the most frequently viewed program and relatively novel program.

According to an example of the present disclosure, the recommended list includes unviewed programs in the same type of programs in the collected information. For example, if it is determined that the user has watched news programs A, B, C, D in a certain time period, there are also news programs E, F, G in that time period, and the user has not watched news programs E, F, G. To enrich the user's viewing experience, news programs E, F, G may be included in the recommended list for that time period.

According to an example of the present disclosure, the sequence of the programs in the recommended list is adjusted according to the user's selection of adding or removing the programs in the recommended list or according to the user's input. For example, a button may be provided in the recommended list to receive user input, through which the user may add or remove a program that he/she doesn't want to watch any more. As another example, the user may adjust the sequence of the programs in the recommended list through the button in the recommended list. Those skilled in the art will understand that the above is only an example for a user to adjust the recommended list, and that the recommended list may be otherwise adjusted.

According to an example of the present disclosure, the recommended list generated for each time period of the weekend is based on information collected about the viewing habits for that time period of the weekend. Users usually have different viewing habits of TV shows on weekends than on weekdays. For example, users may expect to watch a program different from the weekday on weekends because the contents of the weekend program are different, or the user is more available on weekends than on weekdays. In order to generate the recommended list more suitable for a user to use on weekends, a plurality of time periods may be determined at time intervals more suitable for the weekend, and a recommended list for that time period may be generated based on the viewing habits of each time period of the weekend. For example, a morning time period from 10 a.m. to 12 a.m. can be divided for a weekend and information of this period for multiple weekends can be collected. A recommended list specific to the weekend is then generated based on the information collected for that period of the weekend.

Since the recommended list is generated in real time based on the most recent information collected, the generated recommended list can take into account the latest changes in the user's viewing habits. For example, even if a user's viewing habits change significantly during a World Cup period, the resulting recommended list reflects the changes in the viewing habits in a timely manner.

According to an example of the present disclosure, the generated recommended list for the current time period is displayed when the electronic device is activated, when the user switches to the live mode, or through the user selection. That is to say, the generated recommended list may be displayed on the display when the electronic device is activated, such as when the STB is just opened, to provide the user with recommendations when the user starts watching a program. When the user switches to the live mode from the on-demand mode, the user may expect to find the programs of interest in the live mode, and a recommended list can be displayed to help the user make the choice. The recommended list can also be displayed via user input to provide recommendations when required by the user.

By generating a recommended list for different time periods based on viewing habits for different time periods, different users can be better provided with recommendations. Since the recommended list is generated in real time based on information collected about viewing habits for different time periods, the recommended list can reflect changes in the user's viewing habits, which makes the generated recommended list more suitable for different users and can help users find programs of interest faster to provide a better user experience.

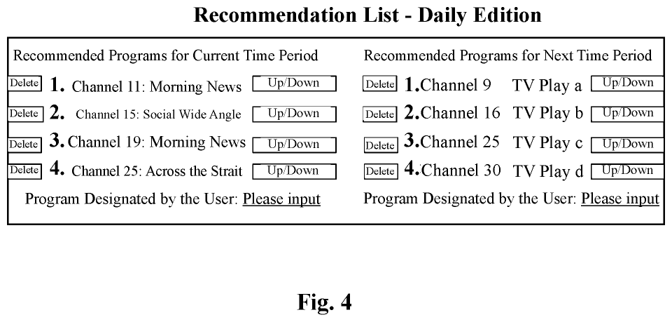

An exemplary diagram of the recommended list generated for weekdays according to examples of the present disclosure will be illustrated below with reference to FIG. 4. Those skilled in the art will understand that the recommended list may be displayed in a pop-up manner, on one side of the screen, or in other proper ways.

As shown in FIG. 4, on the left is the program recommended list for the current time period and on the right is the program recommended list for the next time period. The sequence of programs in the recommended list reflects the recommendation priority of the programs; the program in the first line has the highest the recommendation priority, and the recommendation priority decreases sequentially. Those skilled in the art will understand that program sequence in the recommended list is exemplary only and that the recommended list may be otherwise displayed.

The user can delete a program by using the left button of each recommended program so that the program no longer appears in the recommended list. The user may also use right the button of each recommended program to adjust the sequence of the program in the recommended list, such as moving up to increase the priority or down to reduce the priority.

According to an example of the present disclosure, the program that you want to watch may be specified through user input.

Those skilled in the art will understand that FIG. 4 illustrates the diagram of a recommended list in an exemplary manner only. Recommendation lists according to examples of the present disclosure may be in different forms. For example, according to one example of the present disclosure, the programs in the recommended list may be presented in different categories. For example, the recommendation priority may be determined by program type. Specially recommended programs are displayed in the first line of the program recommended list, followed by generally recommended programs. Each line of recommendation may include multiple programs of the same program type, which may facilitate the user to obtain more program choices from the recommended list, and the way in which the program is classified is also convenient for the user to find and choose the program. According to another example of the present disclosure, for example, the recommended list may display an introductory video of the recommended programs at the appropriate location. The introductory video may be played when the user is interested in selecting the program, such as when the user hovers the selection button over the program. This facilitates the user to further understand the content of the recommended program to make a better choice as to whether or not to watch it. As another example, introductory videos of all recommended programs may be played in a circular manner to enable the user to obtain more recommendation information for making better choices.

Those skilled in the art are capable of understanding that all the steps in the aforementioned method may not appear in an example concurrently and may be flexibly combined to be realized in different examples.

Although some operations in the aforementioned examples are implemented by hardware or software, in general, the operations in the aforementioned examples may be implemented in various configurations and frameworks. Therefore, some or all of the operations in the aforementioned examples may be implemented by hardware, software, or both. For example, at least some operations in the communication technology may be implemented using program instructions 122, the operating system 124 (such as a driver for the interface circuit 118), or firmware in the interface circuit 118 of the electronic device 100. Alternatively or in addition, at least some operations in the communication technology may be implemented at a physical layer, such as hardware in the interface circuit 118 of the electronic device 100.

The present disclosure may be realized as any combination of devices, systems, integrated circuits, and computer programs on non-transitory computer-readable media. One or a plurality of processors may be realized as an integrated circuit (IC), an application-specific integrated circuit (ASIC) or a large-scale integrated circuit (LSI), a system LSI, a super LSI, or an ultra LSI component that executes some or all of the functions described in the present disclosure.

According to each step of the method of the present disclosure, it may also be executed respectively by a plurality of components comprised in the device. According to an example, these components may be realized as computer program modules established to implement various steps of the method, and a device comprising these components may realize the program module structure of the method by computer programs.

The present disclosure comprises the use of software, applications, computer programs, or algorithms. Software, application programs, computer programs or algorithms may be stored on a non-transitory computer-readable medium, so that a computer with one or a plurality of processors may execute the aforementioned steps and the steps described in the attached drawings. For example, one or a plurality of memories save software or algorithms via executable instructions, and one or a plurality of processors may associate a set of instructions executing the software or algorithms to enhance security in any number of wireless networks according to the examples described in the present disclosure.

Software and computer programs (also called programs, software applications, applications, components, or codes) comprise machine instructions for programmable processors, and may be realized in high-level procedural languages, object-oriented programming languages, functional programming languages, logic programming languages, or assembly languages or machine languages. The term “computer-readable medium” refers to any computer application product, apparatus or device used to provide machine instructions or data to the programmable data processor, e.g., magnetic disks, optical disks, solid-state storage devices, memories, and programmable logic devices (PLDs), including computer-readable media that receive machine instructions as computer-readable signals.

For example, the computer-readable medium may include the dynamic random access memory (DRAM), random access memory (RAM), read only memory (ROM), electrically erasable read only memory (EEPROM), compact disk read only memory (CD-ROM) or other optical disk storage devices, magnetic disk storage devices or other magnetic storage devices, or any other medium that may be used to carry or store the required computer-readable program codes in the form of instructions or data structures and may be accessed by a general or special computer or a general or special processor. As used herein, magnetic disks or disks include Compact Discs (CDs), laser disks, optical disks, Digital Versatile Discs (DVDs), floppy disks, and Blu-ray disks, in which magnetic disks usually copy data magnetically, and disks copy data optically via laser. Combinations of the above are also included in the scope of computer-readable media.

In one or a plurality of examples, the use of the words “may”, “able”, “operable as” or “configured as” refers to some devices, logic, hardware and/or elements designed to be used in a specified manner. The subject matter of the present disclosure is provided as an example of the device, system, method, and program for executing the features described in the present disclosure. However, in addition to the aforementioned features, other features or modifications may be expected. It may be expected that any emerging technology that may replace any of the aforementioned realization technologies may be used to complete the realization of the components and functions of the present disclosure.

In addition, the above description provides examples without limiting the scope, applicability, or configuration set forth in the claims. Without departing from the spirit and scope of the present disclosure, changes may be made to the functions and layouts of the discussed elements. Various examples may omit, substitute, or add various processes or components as appropriate. For example, features described with respect to some examples may be combined in other examples.

Similarly, although operations are depicted in a specific order in the attached drawings, this should not be understood as a requirement that such operations should be executed in the specific order shown or in the sequential order, or that all illustrated operations be executed to achieve the desired result. In some cases, multi-tasking and parallel processing may be advantageous.

1. An electronic device, comprising:
a memory, in which instructions are stored; and
a processor, configured to execute the instructions stored in the memory to cause the electronic device to execute the following operations:
determining a plurality of different time periods;
collecting information about viewing habits for the plurality of different time periods; and
generating a recommended list in real time for each of the plurality of different time periods based on the collected information,
wherein the list of recommendations for each time period is based on information collected about the viewing habits for that time period of that day.

2. The electronic device according to claim 1, wherein the processor is further configured to execute the instructions stored in the memory to cause the electronic device to execute the following operation:
displaying the generated recommended list for the current time period when the electronic device is activated, when the user switches to the live mode, or through the user selection.

3. The electronic device according to claim 1, wherein the processor is further configured to execute the instructions stored in the memory to cause the electronic device to execute the following operation:
playing the program with the highest priority in the generated recommended list for the current time period when the electronic device is activated or when the user switches to the live mode.

4. The electronic device according to claim 1, wherein the information about the viewing habits includes one or more of channel number, channel name, the viewing duration, the program name, the viewing time, and the program type.

5. The electronic device according to claim 4, wherein the processor is further configured to execute the instructions stored in the memory to cause the electronic device to execute the following operation:
sequencing the programs in the recommended list based on the viewing duration.

6. The electronic device according to claim 1, wherein the recommended list generated for each time period of the weekend is based on the collected information about the viewing habits for that time period of the weekend.

7. The electronic device according to claim 4, wherein the recommended list includes unviewed programs in the same type of programs in the collected information.

8. The electronic device according to claim 1, wherein the processor is further configured to execute the instructions stored in the memory to cause the electronic device to execute the following operation:
adding or removing programs from the recommended list based on user selection or adjusting the sequence of programs in the recommended list based on user input.

9. A method executable by an electronic device, comprising:
determining a plurality of different time periods;
collecting information about viewing habits for the plurality of different time periods; and
generating a recommended list in real time for each of the plurality of different time periods based on the collected information,
wherein the recommended list for each time period is based on information collected about the viewing habits for that time period of that day.

10. The method according to claim 9, further comprising:
displaying the generated recommended list for the current time period when the electronic device is activated, when the user switches to the live mode, or through the user selection.

11. The method according to claim 9, further comprising:
playing the program with the highest priority in the generated recommended list for the current time period when the electronic device is activated or when the user switches to the live mode.

12. The method according to claim 9, wherein the information about the viewing habits includes one or more of channel number, channel name, the viewing duration, the program name, the viewing time, and the program type.

13. The method according to claim 12, further comprising: sequencing the programs in the recommended list based on the viewing duration.

14. The method according to claim 9, wherein the recommended list generated for each time period of the weekend is based on information collected about the viewing habits for that time period of the weekend.

15. The method according to claim 12, wherein the recommended list includes unviewed programs in the same type of programs in the collected information.

16. The method according to claim 9, comprising:
adding or removing programs from the recommended list based on user selection or adjusting the sequence of programs in the recommended list based on user input.

17. A non-transitory computer-readable medium having instructions stored therein, which, when executed by a processor of an electronic device, cause the electronic device to execute the following operations:
determining a plurality of different time periods;
collecting information about viewing habits for the plurality of different time periods; and
generating a recommended list in real time for each of the plurality of different time periods based on the collected information,
wherein the recommended list for each time period is based on information collected about the viewing habits for that time period of that day.

18. The medium according to claim 17, wherein the instructions, when executed by the processor of the electronic device, further cause the electronic device to perform the following operations:
displaying the generated recommended list for the current time period when the electronic device is activated, when the user switches to the live mode or through user selection.

19. The medium according to claim 17, wherein the instructions, when executed by the processor of the electronic device, further cause the electronic device to perform the following operations:
playing the program with the highest priority in the generated recommended list for the current time period when the electronic device is activated or when the user switches to the live mode.

20. The medium according to claim 17, wherein information about viewing habits includes one or more of channel number, channel name, the viewing duration, the program name, the viewing time, and the program type.

21. The medium according to claim 20, wherein the instructions, when executed by the processor of the electronic device, further cause the electronic device to perform the following operations:
sequencing the programs in the recommended list based on the viewing duration.

22. The medium according to claim 17,
where the recommended list generated for each time period of the weekend is based on information collected about the viewing habits for that time period of the weekend.

23. The medium according to claim 20, wherein the recommended list includes unviewed programs in the same type of programs in the collected information.

24. The medium according to claim 17, wherein the instructions, when executed by the processor of the electronic device, further cause the electronic device to perform the following operations:
adding or removing programs from the recommended list based on user selection or adjusting the sequence of programs in the recommended list based on user input.

25. A computer program product, comprising a computer program, which, when executed by a processor, executes the steps of the method according to claim 9.
